(19) United States
(12) Patent Application Publication
(10) Pub. No.: US 2023/0127792 A1
(43) Pub. Date: Apr. 27, 2023

(54) GLASS CONTAINER WITH A PROTECTIVE COATING OF ACRYLATE URETHANE POLYMER DEPOSITED ON AN EXTERIOR SURFACE OF THE GLASS CONTAINER; METHOD OF PRODUCING SUCH GLASS CONTAINER AND USE OF SUCH GLASS CONTAINER

(71) Applicant: Anheuser-Busch InBev S.A., Brussels (BE)

(72) Inventors: Jonas VANDECRUYS, Leuven (BE); Frederik DE GRAAF, Leuven (BE); Leticia ESTEBAN TEDEJA, Leuven (BE)

(21) Appl. No.: 17/784,787

(22) PCT Filed: Dec. 10, 2020
(86) PCT No.: PCT/EP2020/085449

§ 371 Date: Jun. 13, 2022

(30) Foreign Application Priority Data
Dec. 4, 2019 (DE) 10 2019 132 965.5

(51) Int. Cl. C03C 17/00; C03C 17/32; B65D 1/02; B65D 23/08

(52) U.S. Cl. CPC C03C 17/005; C03C 17/322; B65D 1/0215; B65D 23/0821; C03C 2217/78; C03C 2218/119

(57) ABSTRACT

A glass container comprising: an exterior surface and an interior surface opposite to the exterior surface; and a coating of acrylate urethane polymer deposited at least over a portion of the exterior surface, characterized in that said glass container has a lightweight index L, calculated as L=[weight of container (g)/(volume of container (ml))^{0.77}]*0.44 of less than 1, preferably less than 0.90, more preferably less than 0.75 and most preferably less than 0.60.

### FIELD OF INVENTION

The present invention generally relates to polymer coated glass containers. More particularly, the present invention relates to glass containers coated with an acrylate urethane polymer coating, especially beverage bottles, especially non-returnable beverage bottles.

### BACKGROUND OF INVENTION

Glass containers are widely used and reused in packaging industry, for packing different types of contents, such as liquid, or solids, for example beverages, food, pharmaceutical liquid and solid matter, water or any other matter. Packaged products are also transported to distances for delivery to the end consumers. While producing, filling and transporting, glass containers can get scuffed and scratched due to friction produced between two glass containers while colliding with each other. Additionally, the impact due to collision may also result in breakage of the glass containers. Further, strength of the returnable glass containers may also be affected due to the thermal shock and impact, and collision with each other.

Packaging of content into glass containers depends majorly on the mechanical strength of glass, which is also affected by the processing techniques adopted, including speeds used in the manufacturing and filling of the glass containers; handling equipment used; and/or collision from other packages. The mechanical damage caused to the glass container may be the abrasion of glass, scuffing, and scratching of glass surface. For returnable bottles, also, repeatedly chemically treating of the bottles for cleaning and refilling may affect glass quality that may eventually result in decreasing their life cycle. Such as, treating the returnable glass containers with the caustic bath damages the glass surface. Chemical and thermal treatments are also implemented to strengthen the mechanical durability of glass surface.

Strengthening of the glass surface and glass bottle in general becomes even more critical when light weighing glass bottles. The increasing attention for an environmental friendly industry, pushes the limits on use of materials, on the carbon footprint transport and on sustainability.

When reducing glass thickness to address the environmentally friendly market requests, sustainability of the glass bottle is pushed to the limits and strengthening of the glass becomes a prerequisite to prevent glass failure and hence jeopardizes sustainability of glass bottles.

Hence, a market need remains for providing lightweight glass bottles, in particular beverage bottles having a coating over its outer glass surfaces which positively influence the glass strength, and protect the surface from scuffing and scratching, abrasion and failure.

### SUMMARY OF INVENTION

The present invention addresses the above market need based on the surprising finding that digitally printed acrylate urethan polymer coatings allow light-weighting containers without negatively influencing sustainability of the container.

Therefore, it is an objective of the present invention to provide a glass container having a longitudinal axis, said container comprising:

an exterior surface and an interior surface opposite to the exterior surface; and

a coating of acrylate urethane polymer deposited at least over a portion of the exterior surface, characterized in that said glass container has a lightweight index L, calculated as

L=[weight of container (g)/(volume of container (ml))^{0.77}]*0.44

of less than 1, preferably less than 0.9, more preferably less than 0.75 and most preferably less than 0.60.

It is further an objective of the present invention to provide a method for coating a glass container having a longitudinal axis, said method comprising the steps of:
providing a glass container, said glass container optionally coated with a hot-end coating;
depositing an acrylate urethane polymer on at least a part of an outer surface of said container by a digital printing technique;
curing said acrylate urethane polymer deposited on the container to obtain a coating, characterized in that said glass container has a lightweight index L, calculated as

L=[weight of container (g)/(volume of container (ml))^{0.77}]*0.44

of less than 1, preferably less than 0.9, more preferably less than 0.75 and most preferably less than 0.60.

It is a further objective of the present invention to use a glass container as identified above or as produced by the above method as a container, preferably bottle, for holding a beverage, preferably a carbonated beverage such as beer or cider.

### DETAILED SUMMARY OF THE INVENTION

According to a preferred embodiment of the present invention, wherein the coating has a ratio T, with T equal to

sample standard deviation of the thickness of the coating÷thickness of the coating,

which is measured along a theoretical line extending in a plane normal to the longitudinal axis of the container, at the circumference of the container exterior surface, and with T having a value of maximally 0.062, preferably maximally 0.050, most preferably maximally 0.044.

According to a first embodiment of the present invention, the glass container is a non-returnable (1-way) bottle, preferably having an impact resistance of at least 70 cm/s, preferably at least 120 cm/s, most preferably at least 210 cm/s and/or an internal pressure resistance of at least 12 bar, preferably at least 20 bar.

According to a second embodiment of the present invention, the glass container is a returnable bottle, preferably having an impact resistance of at least 75 cm/s, preferably at least 120 cm/s, most preferably at least 210 cm/s and/or an internal pressure resistance of at least 12 bar, preferably at least 20 bar.

The glass container according to the present invention preferably has an acrylate urethane polymer coating with a average mean thickness of between 20 and 40 μm, which acrylate urethane polymer coating preferably defines an exposed outer contact area of the container, lacking a further coating on top of said acrylate urethane polymer coating. The acrylate urethane polymer coating may be applied on top of a cold-end coating.

The glass container is preferably a beverage bottle, more preferably a carbonated beverage bottle, most preferably a beer bottle or a cider bottle.

### BRIEF DESCRIPTION OF DRAWINGS

FIG. 1 illustrates a flow chart showing a method of coating a glass surface of a glass container, in accordance with an embodiment of the present invention.

FIG. 2 shows a glass bottle according to the present invention.

### DETAILED DESCRIPTION

The present invention provides a unique protective coating over a glass surface of a lightweight glass body for increasing the strength of the glass in terms of impact resistance. The coating also protects the glass surface against scuffing and scratching. In a preferred embodiment, the glass body is a glass container, in particular a glass bottle. According to the present invention, a preferable portion or the whole glass surface is coated with an acrylate urethane polymer coating. An acrylate urethane polymer coating has a very low coefficient of friction, is self-lubricant and very resistant to abrasion. Therefore, the polymer coating of acrylate urethane polymer over the glass surface also protects the glass surface from abrasion, scuffing and scratching, which is usually caused due to friction produced by collision between two glass surfaces. Further, since the acrylate urethane polymer coating is self-lubricant, the glass surface is provided with slippery surface, which prevents two glasses from sticking to each other and hence avoid friction.

The glass container, preferably a beverage bottle, defines an inner space delimited by a body portion extending along a longitudinal axis of the bottle and extending at one side, into a bottom portion at a heel of the bottle that extends into a bottom portion, the body portion extending at its other side, at a shoulder of the bottle, into a neck portion extending into a mouth of the bottle through which the inner space can be accessed for filling and emptying the bottle. In common glass bottle designs, the glass bottle has its largest diameter (measure perpendicular to the longitudinal axis) at the heel and/or at the shoulder portion.

In accordance with the invention the glass bottle has a lightweight index L (as defined by the Japan Glass Bottle Association), calculated as

L=[weight of bottle (g)/(volume of bottle (ml))^{0.77}]*0.44

of less than 1, preferably less than 0.90, more preferably less than 0.75 and most preferably less than 0.60.

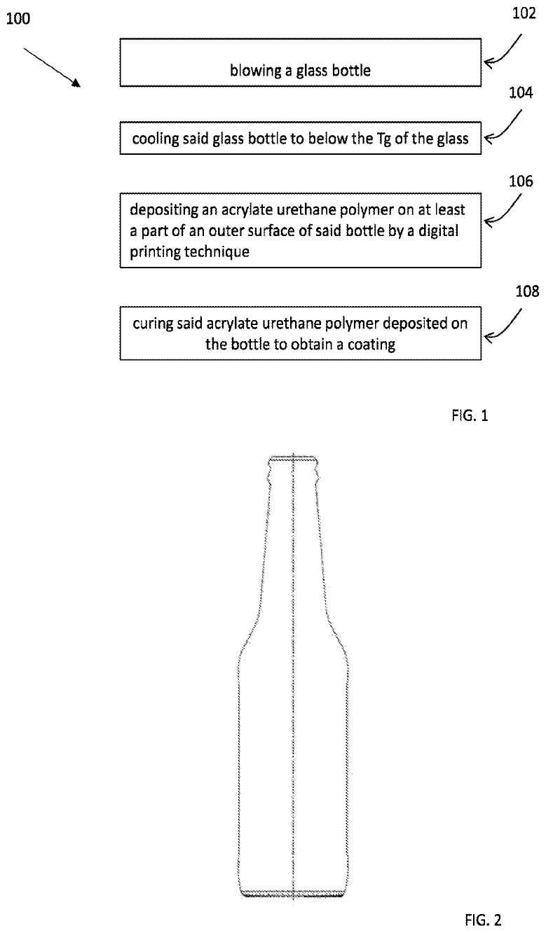

FIG. 1 provides a flow chart showing a method of producing a glass container in accordance with the present invention. As shown, the method 100 comprises a step 102 of blowing a glass container defining an exterior surface and an interior surface opposite to the exterior surface; a step 104 of cooling said glass container to below the Tg of the glass; a step 106 of depositing an acrylate urethane polymer on at least a part of an outer surface of said container by a digital printing technique; and a step 108 of curing said acrylate urethane polymer deposited on the container to obtain a coating, said coating having a uniform thickness that is characterized by a ratio T, with T equal to

sample standard deviation of the thickness of the coating÷thickness of the coating,

measured along a theoretical line extending in a plane normal to the longitudinal axis of the container at the circumference of the container exterior surface, and with T having a value of maximally 0.062, preferably maximally 0.050, most preferably maximally 0.044.

The container, preferably a glass bottle, thus produced can be either a non-returnable (1-way) bottle or a returnable bottle upon which the coating is applied with preferably an average mean thickness of between 20 and 40 μm.

In case of a 1-way bottle that is usually light-weight and designed to maintain functional during filling, transport and consuming cycle, the coating allows for increasing the impact resistance of the bottle to at least 70 cm/s, preferably at least 120 cm/s and most preferably at least 210 cm/s and/or for increasing the internal pressure resistance of the bottle to at least 12 bar, preferably at least 20 bar. This is particularly suitable for bottles used to hold carbonated beverages such as beer.

In case of returnable bottles, which are designed to maintain functional during a series of six or more cycles of filling, transport, consuming and cleaning, the coating allows for increasing the impact resistance of the bottle to at least 70 cm/s, preferably at least 120 cm/s and most preferably at least 210 cm/s and/or for increasing the internal pressure resistance of the bottle to at least 12 bar, preferably at least 20 bar. Again, this is particularly suitable for bottles used to hold carbonated beverages such as beer.

Irrespective of the type of container or in particular bottle, the volume to be contained therein preferably ranges between 10 cl and 1.2 l.

Acrylate Urethane Coatings

Generally, urethane acrylates are prepared from isocyanates, polyols, acrylates. Examples of the isocyanate include hexamethylene diisocyanate, trimethylhexamethylene diisocyanate, toluene diisocyanate, isophorone diisocyanate, phenyl isocyanate, naphthyl isocyanate and the like. Examples of the polyol include polyether polyol, polyester polyol, acryl polyol, polysiloxane polyol and the like. Examples of the polyester polyol include polyethylene glycol, polypropylene glycol, polyol composed of a copolymer of ethylene oxide and propylene oxide, polytetramethylene glycol and the like. Examples of the polyester polyol include caprolactone polyol, polycarbonate polyol and the like.

Acrylate is preferably one having a hydroxyl group and one or more acrylic groups and examples of the hydroxyacrylate having a single acrylic group include hydroxyethyl acrylate, hydroxyacyl (meth) acrylate, hydroxypropyl acrylate, Hydroxybutyl acrylate and the like. Examples of the hydroxyacrylate having a plurality of (preferably 2 or more and 4 or less) acrylic groups include pentaerythritol triacrylate and the like.

In order to obtain urethane acrylate having a plurality of acrylic groups on at least one side of the main chain terminal, it is preferable to use hydroxy acrylate having a plurality of acryl groups. Digitally printing of the urethane coating allows an improved control on the thickness and uniformity of the coating when compared to other application techniques such as screen printing or spraying. Such improved control results in coating that are less prone to surface effects and are believed to be more environmentally friendly in terms of use of material and in energy consumption for application and curing.

Impact Resistance Test Method

Typically, impacts are carried out at the contact point for that particular item, such as shoulder and heel for bottles or the rim of a pint glass and the testing is carried out until failure of the sample occurs. However, client requests such as testing until first damage is visible or at specific impact positions can also be undertaken. For the present invention, values provided in this specification are measured at the shoulder of the bottle and in accordance with an industry standard, calibrated, AGR impacter and UKAS accredited under ISO 17025.

### EXAMPLE

A glass bottle as shown in FIG. 2, was coated with a method in accordance with the present invention and subsequently the thickness of the coating was measured at 12 equidistant points along a theoretical line along the circumference of the bottle exterior surface extending in a plane normal to the longitudinal axis of the bottle. This measurement was repeated to collect data from three theoretical lines at the shoulder of the bottle and from three theoretical lines at the heel of the bottle. The results are shown in table 1 below.

TABLE 1

| | | Shoulder (μm) | | | | | | | | | | | | | | |
|---|---|---|---|---|---|---|---|---|---|---|---|---|---|---|---|---|
| Position | | 0* | 30* | 60* | 90* | 120* | 150* | 180* | 210* | 240* | 270* | 300* | 330* | AVG | SD | SD/AVG |
| Measurement | 1 | 27 | 26 | 27 | 28 | 28 | 30 | 28 | 26 | 28 | 27 | 27 | 27 | 27,417 | 1,084 | 0.040 |
| location in | 2 | 28 | 27 | 29 | 30 | 29 | 25 | 30 | 28 | 26 | 28 | 28 | 25 | 27,750 | 1,712 | 0.062 |
| picture | 3 | 26 | 29 | 28 | 29 | 29 | 28 | 30 | 28 | 28 | 28 | 30 | 27 | 28,333 | 1,155 | 0.041 |
| | | Heel (μm) | | | | | | | | | | | | | | |
| Position | | 0* | 30* | 60* | 90* | 120* | 150* | 180* | 210* | 240* | 270* | 300* | 330* | AVG | SD | SD/AVG |
| Measurement | 1 | 25 | 28 | 24 | 26 | 27 | 27 | 25 | 26 | 25 | 26 | 26 | 27 | 26,000 | 1,128 | 0.043 |
| location in | 2 | 25 | 26 | 26 | 25 | 26 | 26 | 25 | 24 | 26 | 26 | 27 | 25 | 25,583 | 793 | 0.031 |
| picture | 3 | 25 | 27 | 25 | 28 | 28 | 27 | 26 | 27 | 27 | 27 | 25 | 25 | 26,417 | 1,165 | 0.044 |

1. A glass container comprising:
an exterior surface and an interior surface opposite to the exterior surface; and
a coating of acrylate urethane polymer deposited at least over a portion of the exterior surface, characterized in that said glass container has a lightweight index L, calculated as
L=[weight of container (g)/(volume of container (ml))^{0.77}]*0.44
of less than 1, preferably less than 0.90, more preferably less than 0.75 and most preferably less than 0.60.

2. The glass container according to claim 1, wherein said coating is characterized by a ratio T, with T equal to
sample standard deviation of the thickness of the coating÷thickness of the coating,
measured along a theoretical line extending in a plane normal to the longitudinal axis of the container at the circumference of the container exterior surface, has a value of maximally 0.062, preferably maximally 0.050, most preferably maximally 0.044.

3. The glass container according to claim 1, said container having an internal pressure resistance of at least 12 bar, preferably at least 20 bar.

4. The glass container according to claim 1, having an impact resistance of 70 cm/s, preferably 120 cm/s, most preferably 210 cm/s.

5. The glass container according to claim 1, having an internal volume of between 10 cl and 1.2 l.

6. The glass container according to claim 1, said acrylate urethane polymer coating having an average mean thickness of between 20 and 40 μm.

7. The glass container according to claim 1, said acrylate urethane polymer coating defining an exposed outer contact area of the container, lacking a further coating on top of said acrylate urethane polymer coating.

8. The glass container according to claim 1, said acrylate urethane polymer coating applied on top of a hot-end coating.

9. The glass container according to claim 1, said container being a beverage bottle, preferably a carbonated beverage bottle.

10. The glass container according to claim 9, said bottle being a beer or cider bottle.

11. The glass container according to claim 1, said glass container being a returnable or a non-returnable glass bottle.

12. Method of coating a glass container having a longitudinal axis, said method comprising the steps of:
providing a glass container, said glass container optionally coated with a hot-end coating;
depositing an acrylate urethane polymer on at least a part of an outer surface of said container by a digital printing technique;
curing said acrylate urethane polymer deposited on the container to obtain a coating, characterized in that said glass container has a lightweight index L, calculated as
L=[weight of container (g)/(volume of container (ml))^{0.77}]*0.44
of less than 1, preferably less than 0.90, more preferably less than 0.75 and most preferably less than 0.60.

13. Method according to claim 1, wherein said coating is characterized by a ratio T, with T equal to
sample standard deviation of the thickness of the coating÷thickness of the coating
measured along a theoretical line extending in a plane normal to the longitudinal axis of the container, at the circumference of the container exterior surface -, has a value of maximally 0.062, preferably maximally 0.050, most preferably maximally 0.044.

14. Use of a glass bottle as identified in claim 1, for holding a beverage, preferably a carbonated beverage.

15. Use of a glass container as identified in claim 1 for holding beer or cider.
